(19) United States
(12) Patent Application Publication
(10) Pub. No.: US 2026/0140254 A1
(43) Pub. Date: May 21, 2026

(54) BIRD'S EYE VIEW OBJECT DETECTION WITH ONLINE DEPTH RECTIFICATION USING SINGLE MODALITY DETECTIONS

(71) Applicant: Torc Robotics, Inc., Blacksburg, VA (US)

(72) Inventor: Bin Jia, Columbia, MD (US)

(21) Appl. No.: 18/950,794

(22) Filed: Nov. 18, 2024

(51) Int. Cl. G01S 13/86; B60W 60/00; G01S 7/41; G01S 13/89; G06T 7/55

(52) U.S. Cl. CPC G01S 13/865; G01S 7/417; G01S 13/867; G01S 13/89; G06T 7/55; B60W 60/00; B60W 2420/403; B60W 2420/408; B60W 2556/35; G06T 2207/10028; G06T 2207/20084; G06T 2207/30252

(57) ABSTRACT

An autonomy computing system including at least one memory configured to store machine executable instructions, and at least one processor coupled to the at least one memory is disclosed. The at least one processor is configured to execute the instructions to: (i) obtain a two-dimensional (2D) image feature from a plurality of images, the plurality of images generated based upon sensor data from a plurality of camera sensors; (ii) unproject the 2D image feature to a three-dimensional (3D) space to obtain a 3D image feature; (iii) estimate depth information for each pixel of a plurality of pixels, the plurality of pixels representing a portion of an image of the plurality of images; (iv) for the each pixel, predict depth error compensation, based upon the estimated depth information, to generate rectified depth information; and (v) generate a 3D object detection list using the rectified depth information and the 3D image feature.

### TECHNICAL FIELD

The field of the disclosure relates generally to perception technologies of an autonomous vehicle and, more specifically, bird's eye view (BEV) object detection with online depth rectification using single modality detections.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Accurate depth information is critical for operation of an autonomous vehicle. Depth information can be obtained, for example, using sensor data of a monocular or stereo camera. However, due to, for example, vibrations or calibration issues, the depth information cannot be accurately determined by an upstream depth estimation network (e.g., a neural network for estimating depth from sensor data of a camera). For example, vibrations cause an original mounting position of a sensor to change, and incorrect calibration can also disrupt processing of sensor data from the sensor.

BEV perception and multi-sensor fusion can simulate rapid progress for autonomous driving. The BEV coordinates naturally unify various downstream object-level and scene-level perception tasks. Using sensor data from multiple sensors such as, a camera sensor and a light detection and ranging (LiDAR) sensor, minimizes uncertainty, resulting in more robust and accurate predictions. However, without accurate depth estimation for each modality based on the camera sensor and the LiDAR sensor, fusion of sensor data from the multiple sensors for BEV perception becomes challenging. Further, multi-modality information fusion based upon inaccurate depth estimation may also lead to poor object detection or BEV perception performance.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system including at least one memory configured to store machine executable instructions and at least one processor coupled to the at least one memory is disclosed. The at least one processor is configured to execute the machine executable instructions to: (i) obtain a two-dimensional (2D) image feature from a plurality of images, the plurality of images generated based upon sensor data from a plurality of camera sensors; (ii) unproject the 2D image feature to a three-dimensional (3D) space to obtain a 3D image feature; estimate depth information for each pixel of a plurality of pixels, the plurality of pixels representing a portion of an image of the plurality of images; (iii) estimate depth information for each pixel of a plurality of pixels, the plurality of pixels representing a portion of an image of the plurality of images; (iv) for the each pixel, predict depth error compensation, based upon the estimated depth information, to generate rectified depth information; and (v) generate a 3D object detection list using the rectified depth information and the 3D image feature.

In another aspect, an autonomous vehicle including a plurality of sensors, at least one memory configured to store machine executable instructions and at least one processor coupled to the at least one memory is disclosed. The plurality of sensors includes one or more camera sensors, one or more light detection and ranging (LiDAR) sensors, or one or more radio detection and ranging (RADAR) sensors. The at least one processor is configured to execute the machine executable instructions to: (i) obtain a two-dimensional (2D) image feature from a plurality of images, the plurality of images generated based upon sensor data from a plurality of camera sensors; (ii) unproject the 2D image feature to a three-dimensional (3D) space to obtain a 3D image feature; estimate depth information for each pixel of a plurality of pixels, the plurality of pixels representing a portion of an image of the plurality of images; (iii) estimate depth information for each pixel of a plurality of pixels, the plurality of pixels representing a portion of an image of the plurality of images; (iv) for the each pixel, predict depth error compensation, based upon the estimated depth information, to generate rectified depth information; and (v) generate a 3D object detection list using the rectified depth information and the 3D image feature.

In yet another aspect, a computer-implemented method is disclosed. The method includes: (i) obtaining a two-dimensional (2D) image feature from a plurality of images, the plurality of images generated based upon sensor data from one or more camera sensors; (ii) unprojecting the 2D image feature to a three-dimensional (3D) space to obtain a 3D image feature; (iii) estimating depth information for each pixel of a plurality of pixels, the plurality of pixels representing a portion of an image of the plurality of images; (iv) for the each pixel, predicting depth error compensation, based upon the estimated depth information, to generate rectified depth information; and (v) generating a 3D object detection list using the rectified depth information and the 3D image feature.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is an illustration of an example depth error effect;

FIG. 5 is a block diagram of an example embodiment of a bird eye view (BEV) detection network for BEV detection with online depth corrections;

FIG. 6 is an illustration of an example of depth compensation;

FIG. 7 is an illustration of an example depth compensation calculation;

FIG. 8 is a block diagram of an example depth compensator pipeline;

FIG. 9A is an illustration of an example ground truth depth error;

FIG. 9B is an illustration of an example absolute error of a predicted depth error estimation;

FIG. 9C is an illustration of another example absolute error of the predicted depth error estimation; and

FIG. 10 is a flow diagram of an embodiment method of BEV object detection with online depth rectification.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

As described herein, accurate depth information is critical for operation of an autonomous vehicle. Depth information can be obtained, for example, using sensor data of a monocular or stereo camera. However, due to, for example, vibrations or calibration issues, the depth information cannot be accurately determined by an upstream depth estimation network (e.g., a neural network for estimating depth from sensor data of a camera). For example, vibrations may cause changes in an original mounting position of a sensor which is being used in computing the depth information. Similarly, incorrect calibration of the sensor may cause sensor data for depth information computation being processed incorrectly.

Further, as described herein, BEV perception and multi-sensor fusion can simulate rapid progress for autonomous driving. The BEV coordinates naturally unify various downstream object-level and scene-level perception tasks. Using sensor data from multiple sensors such as, a camera sensor and a light detection and ranging (LiDAR) sensor, minimizes uncertainty, resulting in more robust and accurate predictions. However, without accurate depth estimation for each modality based on the camera sensor and the LiDAR sensor, fusion of sensor data from the multiple sensors for BEV perception becomes challenging. Further, multi-modality information fusion based upon inaccurate depth estimation may also lead to poor object detection or BEV perception performance.

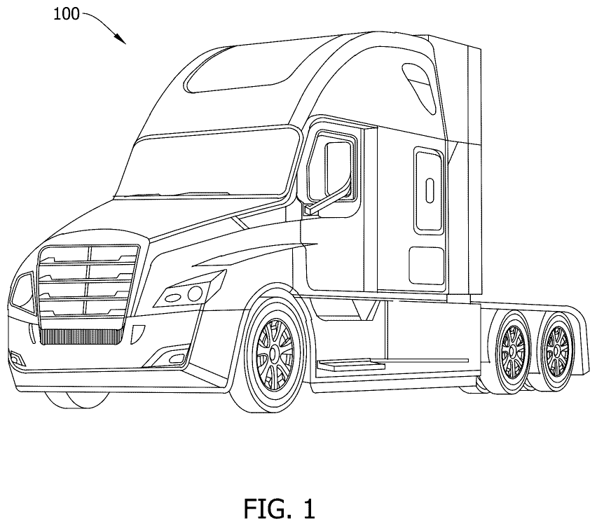

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

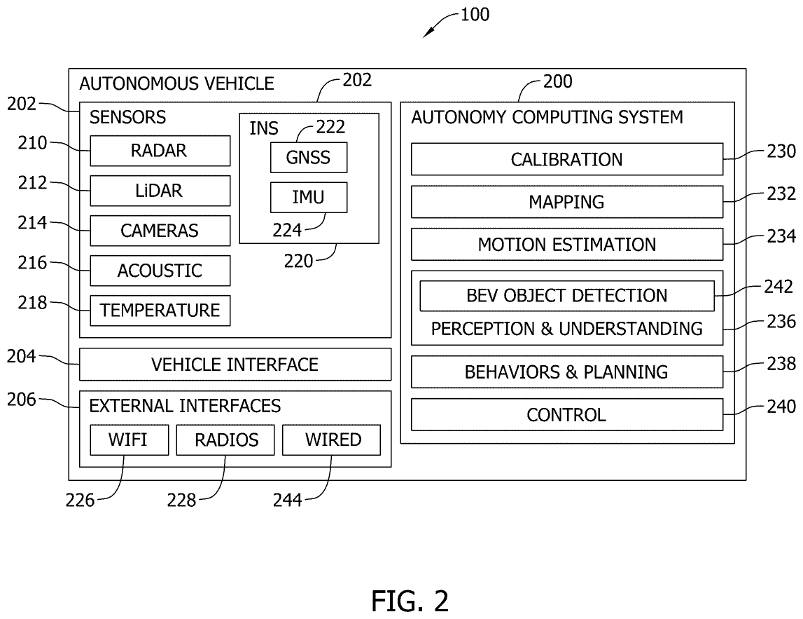

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LIDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a BEV object detection module 242. The BEV object detection module 242, for example, may be embodied within another module, such as perception and understanding module 236, behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The BEV object detection module 242 processes sensor data from one or more camera sensors and generates 3D objects or 3D features based upon rectified depth information that is generated as described in detail in the present disclosure.

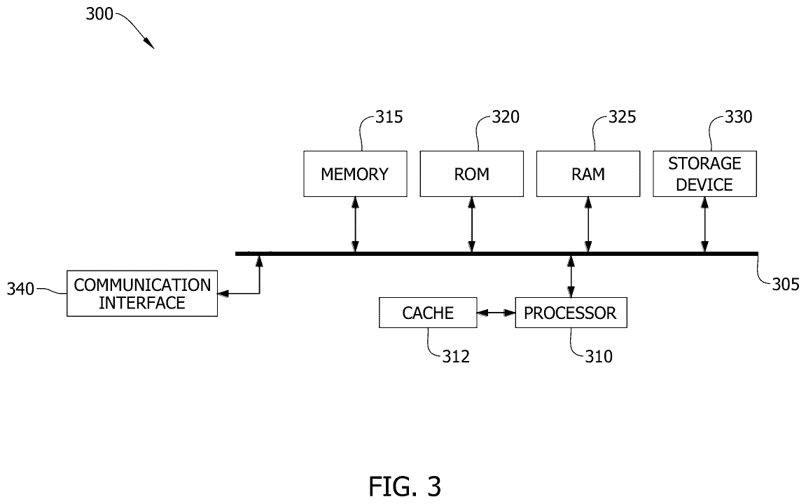

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

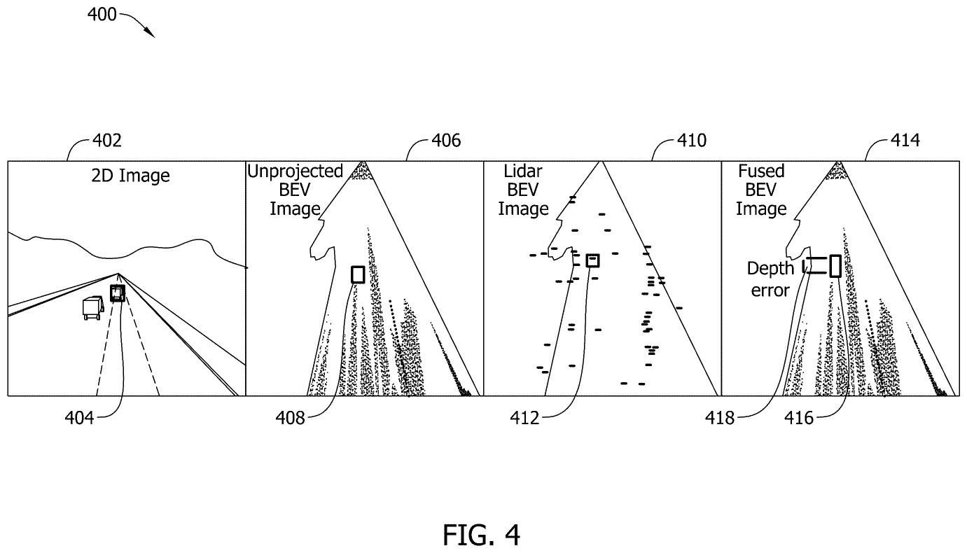

FIG. 4 is an illustration 400 of a depth error effect caused by the conventional fusion approach. In the conventional fusion approach, multi-modal BEV space fusion is performed using sensor data of a camera and sensor data of a LiDAR. The camera may be a monocular camera or stereo cameras, such as cameras 214 shown in FIG. 2. Referring to FIG. 4, a two-dimensional (2D) image 402 is generated based upon sensor data of the camera. In a BEV object detection model, which may be based upon a machine learning model or a deep neural network, depth information is used to project features of a 2D image into a three-dimensional (3D) space and subsequently fusion with 3D LiDAR features. The 3D LiDAR features are based upon sensor data of a LiDAR sensor, such as LiDAR sensor 212 shown in FIG. 2.

For example, a feature of interest 404 is shown in the 2D image. The feature of interest 404 may be shown as feature of interest 408 in an unprojected BEV image 406 of the 2D image 402, and as feature of interest 412 in a BEV image 410. The BEV image 410 is based upon sensor data of the LiDAR. A fused BEV image 414 is based upon fusion of the unprojected BEV image 406 and the BEV image 410. Fused BEV image 414 shows a feature of interest 416 corresponding to feature of interest 404. A depth error 418, as shown in the fused BEV image 414, causes the fusion output of a BEV object detection model to degrade and lead to poor object detection performance.

Further, even with a well-trained neural network or machine learning model for the BEV object detection, depth estimation using multi-modality fusion network suffers from various performance issues such as, but not limited to, sensor misalignment and calibration errors between different sensors, data synchronization and latency issues between different sensors. Additionally, adaptive improvement to performance of such an offline trained BEV object detection model for online usage is difficult. Further, single modality BEV object detection models have disadvantages when compared to multi-modality fusion framework-based BEV object detection. The single modality BEV object detection models are models trained to generate BEV models for object detection using sensor data from a single (or a single type of) sensor (e.g., a camera sensor or a LiDAR sensor). Similarly, the multi-modality fusion framework-based BEV object detection models are models trained to generate BEV models for object detection using sensor data more than one (or more than one types of) sensor (e.g., a camera sensor and a LiDAR sensor).

Embodiments of the disclosed BEV object detection framework (or an end-to-end network) include a rectification process for object detection using a single modality in which an online depth rectifier adaptively estimates a depth error in an online or real-time manner and unifies the detected object from single modality and multi-modalities in a cohesive manner such that the depth error defect occurring with the conventional approaches, as shown in FIG. 4, does not occur. The online depth rectifier may be part of an end-to-end network. Alternatively, the online depth rectifier may be a separate module or component adaptively estimating a depth error in an online or real-time manner and unifying the detected object from single modality and multi-modalities in a cohesive manner for the proposed BEV object detection framework.

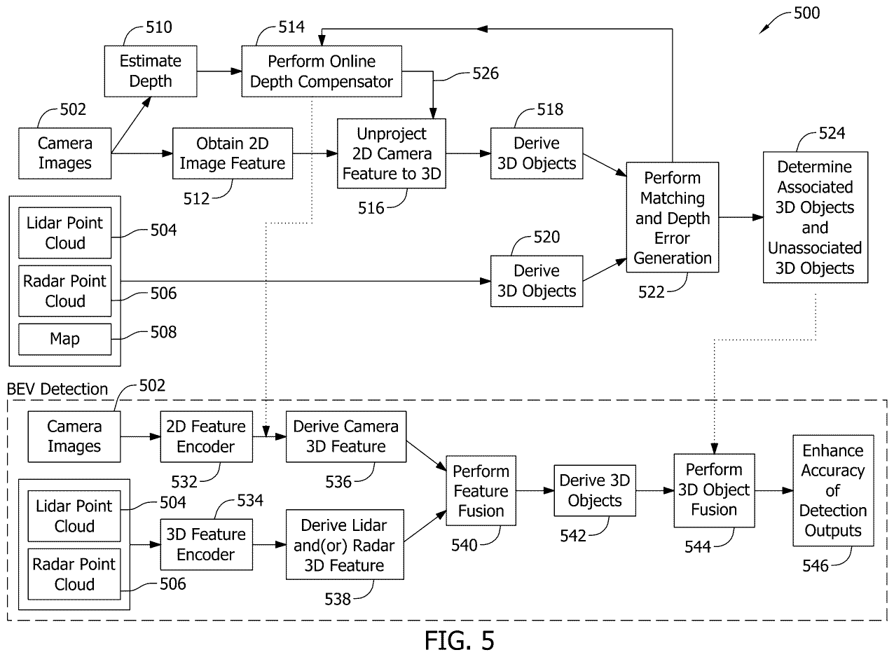

FIG. 5 illustrates an example embodiment of a BEV detection network 500 for BEV detection with online depth corrections using an online depth rectifier (or an online depth rectification module). In the BEV detection network 500, rectified depth information 526 is used to unproject 516 a 2D image feature vector (also referenced herein as 2D image feature) 512 to derive or obtain a 3D image feature 536 into a 3D space. In other words, the unproject 516 maps a 2D point from a view's coordinate system to a 3D plane by transforming a point in the view's coordinate system to define the 3D plane's coordinate system. The unproject 516 returns the 3D position in world coordinates if the mapping is possible, or nil if it is not. Camera images 502 may be generated by camera sensor 214 shown in FIG. 2. The 2D image feature vector 512 is obtained from camera images 502 via a 2D feature encoder 532. By way of a non-limiting example, the 2D feature encoder 532 may be implemented using a deep learning architecture, for example, a residual neural network (ResNet) that is generally used for computer vision or image recognition tasks.

Generally, LiDAR 3D features 504 or RADAR 3D features 506 may be fused using a 3D feature encoder 534 to derive or obtain a 3D image feature 538, and the fused vector (or fused feature as referenced herein) is then used by a detection head (not shown in FIG. 5) to perform concatenation of feature maps of LiDAR 3D features 504 or RADAR 3D features 506 with a feature map 508 based on sensor data of a camera. A final feature map is generated by the detection head based upon the concatenated feature maps for an object detection including generating a label and a bounding box for the object. Accordingly, the fused features may provide 3D objects by performing a feature level fusion process 540.

However, using the online depth rectifier 514, computed or obtained rectified depth information 526 and the 3D image feature or objects 518 from the unprojected 516 2D image features 512 can be directly used by the detection head without fusion with the feature map of LiDAR 3D feature 504 or RADAR 3D feature 506 to generate the 3D object detection list (e.g., a first 3D object detection list) 518. Further, the feature map of LiDAR 3D feature 504 or RADAR 3D feature 506 may be used by the detection head to provide or derive another 3D object detection list (e.g., a second 3D object detection list) 520 that is solely based on sensor data of a LiDAR or a RADAR. The first 3D object detection list 518 and the second 3D object detection list 520 are matched by performing matching and depth error generation 522 to determine associated 3D objects and unassociated 3D objects 524. Alternatively, or additionally, the object association can be performed in 2D image space using the projected 3D objects based upon sensor data of the LiDAR or RADAR in the 2D image space. An object, as described herein, may be a bounding box, a point, or any other shape.

In an example embodiment, based upon the association between 3D objects 524 detected using single modality, the 3D objects are derived 542 using fusion technique 540, which may be further fused by performing feature level fusion 544 again, thereby enhancing the robustness and accuracy of the detection head output 546. In particular, an uncertainty from the fused 3D objects is reduced to small values. For the unassociated 3D objects using single modality, because they are critical to complement the feature level fusion outputs, the unassociated objects are directly added to the final object detection list with large uncertainty.

In an example embodiment, the online depth rectifier 514 operates together with the matching and depth error generation 522 associates the first 3D object detection list 518 from camera branch and the second 3D object detection list 520 from LiDAR/RADAR branch. By way of a non-limiting example, for each 3D object, a respective position p may be represented using p=[x, y, z], and the depth estimation unit 510 (also referenced herein an upstream neural network) provides the depth information 526 for each pixel of each the 2D camera images 502. Accordingly, a matrix may be generated to represent the depth information.

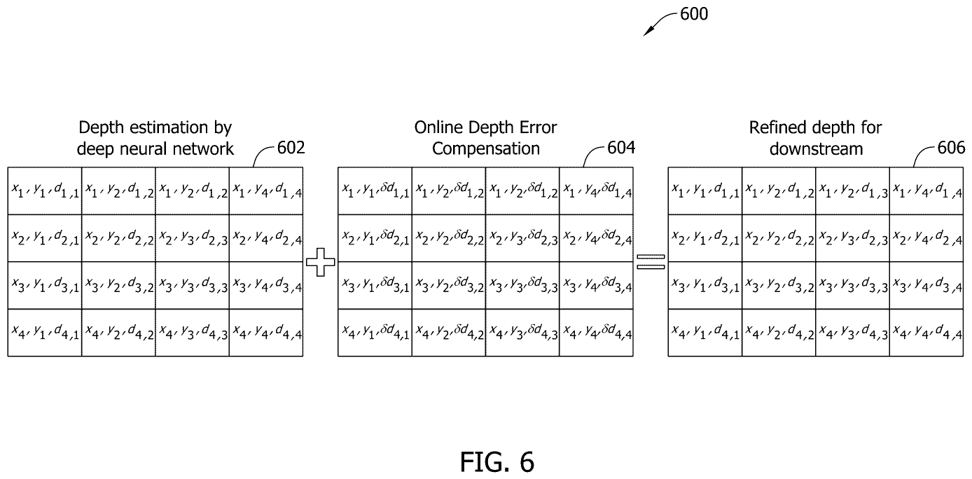

FIG. 6 is an illustration of an example depth compensation 600 with a depth estimation 602, and an online depth error compensation 604 for a refined depth 606 for downstream components (e.g., the rectified depth information 526). The depth estimation 602 may be provided by a deep neural network (e.g., depth estimation unit 510), and the online depth error compensation 604 may be provided by the online depth compensator 514.

In an example embodiment, to rectify the depth, the online depth compensator 514 receives a stream of samples at previous time instances. The stream of samples at previous time instances may perform or act as training samples to generate an output. The output of the online depth compensator 514 may be predicted depth compensation values [xᵢ,yⱼ,δdᵢⱼ] at the current time instance, where i=1, . . . , M, j=1, . . . , N, and M and N are the height and width of the depth image (matrix), respectively. For example, an associated object pair for LiDAR/RADAR and camera is represented by P_{l,w} and P_{c,w}, respectively, where w denotes the 3D world coordinate system. However, given the extrinsic and intrinsic parameters of the camera and LiDAR/RADAR, a mapping relation between the 3D world coordinate system to the 2D camera coordinate may be represented by [x_{i,c},y_{j,c}]=f(p_{c,w}) and [x_{i,l},y_{j,i}]=f(p_{l,w}) where f is a non-linear mapping relation (or a non-linear mapping function).

Due to noise in association and calibration parameters, the depth value estimated from sensor data may include some amount of error. For the machine learning based depth estimation, the accuracy highly depends on the ground truth. To train the model, the depth values of semantic objects in the ground truth and the predicted depth values of semantic objects need to be correctly associated. For example, if we are interested in the truck, the truck in the ground truth dataset and the truck predicted by the network should be correctly associated. However, there are many association methods with various parameters. Noises are from mismatches and ground truth fidelity. In addition, the calibration parameters are often used in the neural network as a necessary information to transform the data between different coordinate systems. However, such information can be corrupted due to mechanical vibrations and environmental effects. Accordingly, in some embodiments, an error compensation value is trained for each value in the depth image or depth matrix. However, due to a limited number of the matched object pairs, the depth error compensation value may be inferred at other locations on the depth image or depth matrix having no observations. Further, to reduce the cost of computation and achieve real-time performance requirement, an online machine learning algorithm may be used to learn the depth compensation values with samples from historical timestamps.

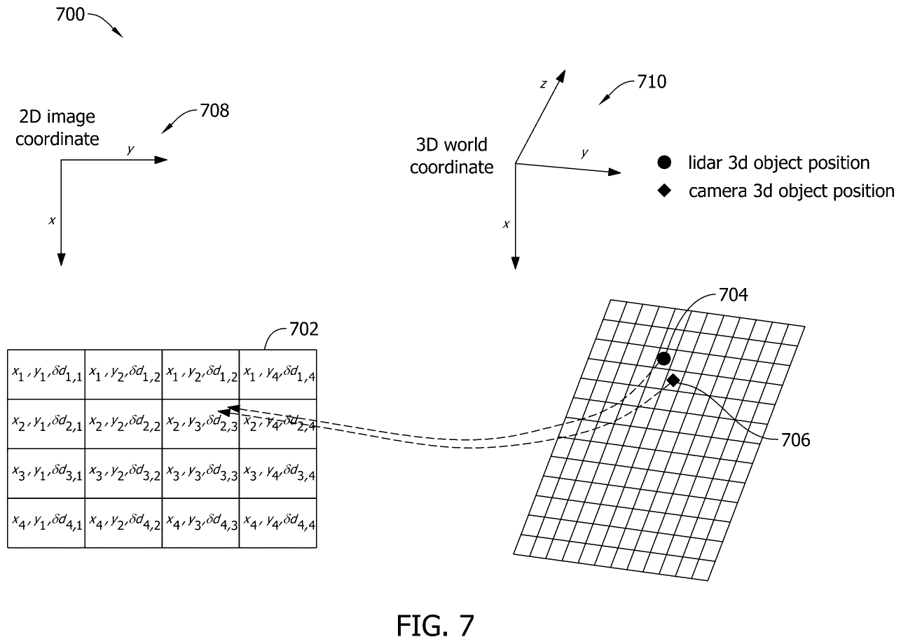

FIG. 7 is an illustration of an example depth compensation calculation process 700 that is based on a training sample described by a formula

$$[ {x}_{i} , {y}_{j} , δ d ] = [ {x}_{i , c} , {y}_{j , c} , sign ( D ) \sqrt{{( {x}_{i , c} - {x}_{i , l} )}^{2} + {( {y}_{j , c} - {y}_{j , l} )}^{2}} ,$$

$$where D = \sqrt{{x}_{i , l}^{2} + {y}_{i , l}^{2}} - \sqrt{{x}_{i , c}^{2} + {y}_{i , c}^{2}} ,$$

sign(D) returns 1 if D is not less than 0, and sign(D) returns −1 otherwise. The formula above is used to determine an angular difference between two objects. However, in alternative embodiments, a formula different than the formula described herein may also be used. For a depth image or a depth matrix 702 in a 2D coordinate system 708 the LiDAR/RADAR 3D object position 704 and the camera 3D object position 706 in the 3D world coordinate system 710 may be as shown in FIG. 7. Given the depth information, the 2D image pixel can be unprojected to 3D space. Further, based upon the depth correction information, the depth can be further refined by adding the depth correction. With the refined depth, each pixel can be unprojected from 2D to 3D.

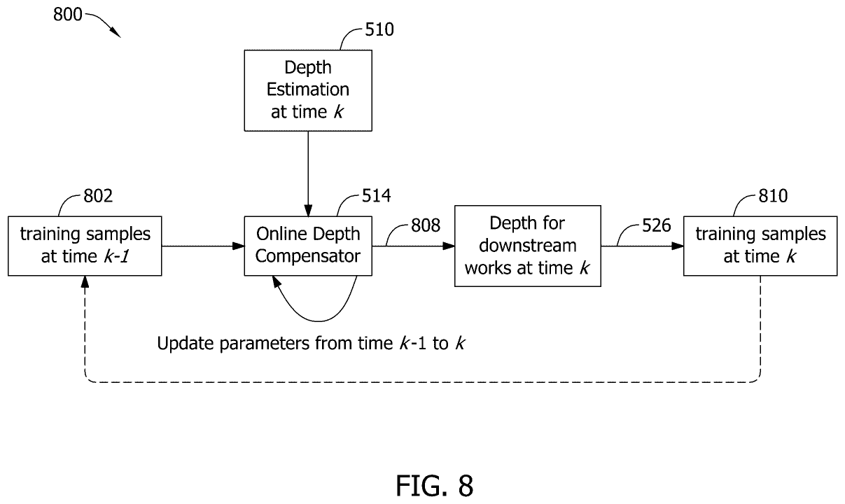

FIG. 8 is block diagram of an example online depth compensator pipeline 800, which may be similar to and perform similar functions of depth compensator 514 shown in FIG. 5. In the embodiment shown in FIG. 8, the online machine learning algorithm is trained to learn the depth compensation values using depth compensator pipeline 800. The depth compensator pipeline 800 may be based upon an online Gaussian process. For example, for the samples 802 (e.g., training samples) up to time k−1, the model parameters/hyperparameters of the online machine learning algorithm may be learned using the historical training samples 802 up to time k−1. The online depth rectifier 514 (or the depth compensator 514) predicts the current depth compensation values 808 at time k. Based upon the estimated depth compensation values 808 at the current time k, the refined depth information 526 can be consumed by downstream users or components. When the samples at time k 810 are available, the model parameters are updated accordingly to the next time k+1 (not shown in FIG. 8), and thus the process is recursively performed. As described herein, the process uses previous samples as inputs, and generates current upstream depth compensation value as an output. At each time instant, the new depth compensation value given by depth compensator 514 is used by downstream tasks or downstream users. In the present disclosure, the depth compensator 514 is used for BEV object detection; however, the depth compensator 514 may be used with any scene understanding tasks in which depth of a camera image is critical information such as, multi-sensor Bayesian tracking or an actor fusion.

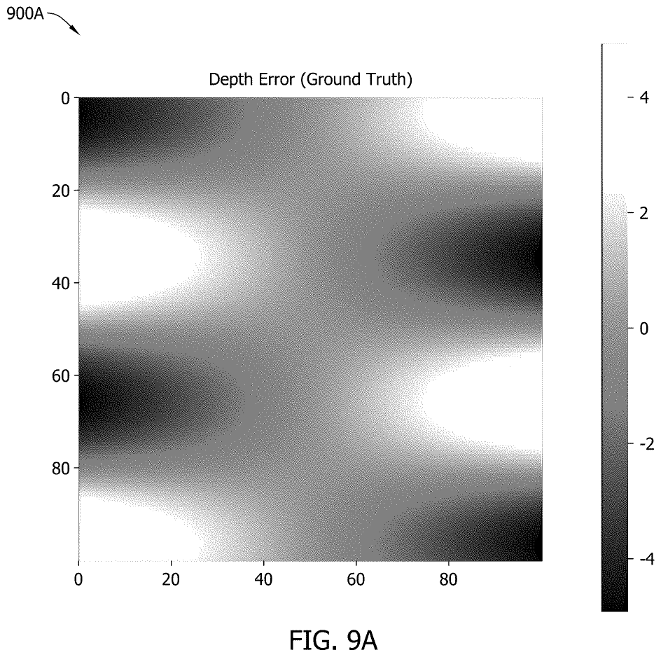

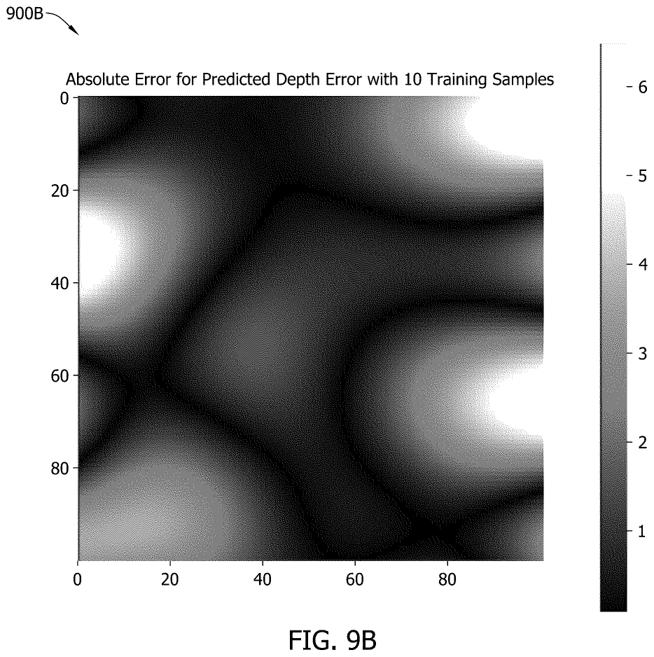

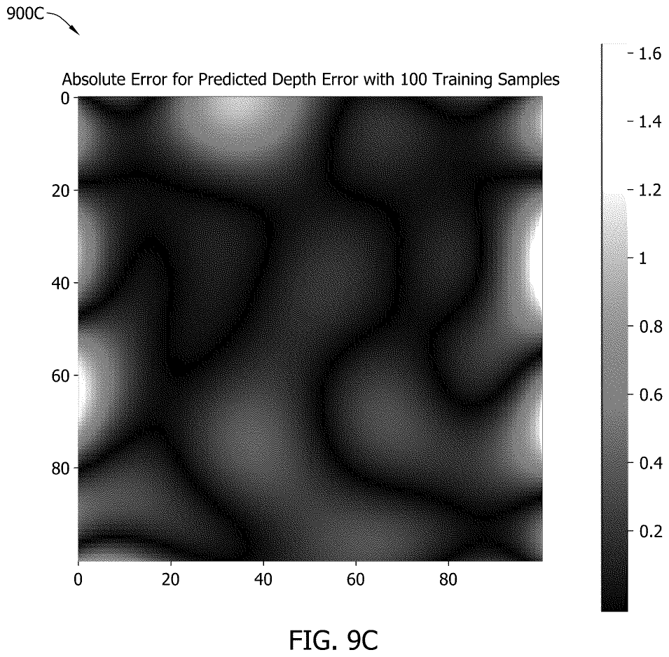

FIG. 9A illustrates an example ground truth depth error 900A for a numerical test performed with depth image size of 100×100 according to the disclosed embodiments. FIG. 9B illustrates an example absolute error of a predicted depth error estimation 900B by the depth compensator 514 (shown in FIG. 5), and FIG. 9C illustrates another example absolute error of the predicted depth error estimation 900C by the depth compensator 514. In particular, FIG. 9B illustrates an absolute error of the predicted depth estimation using 10 training samples. In comparison, FIG. 9C illustrates an absolute error of the predicted depth estimation using 100 training samples. In an example embodiment, for each training sample, Gaussian noise with a mean value of 0 and standard deviation of 0.1 may be applied. More training samples are collected or gathered over time and, as shown in FIG. 9B and FIG. 9C, the estimated depth error decreases with the increased number of training samples.

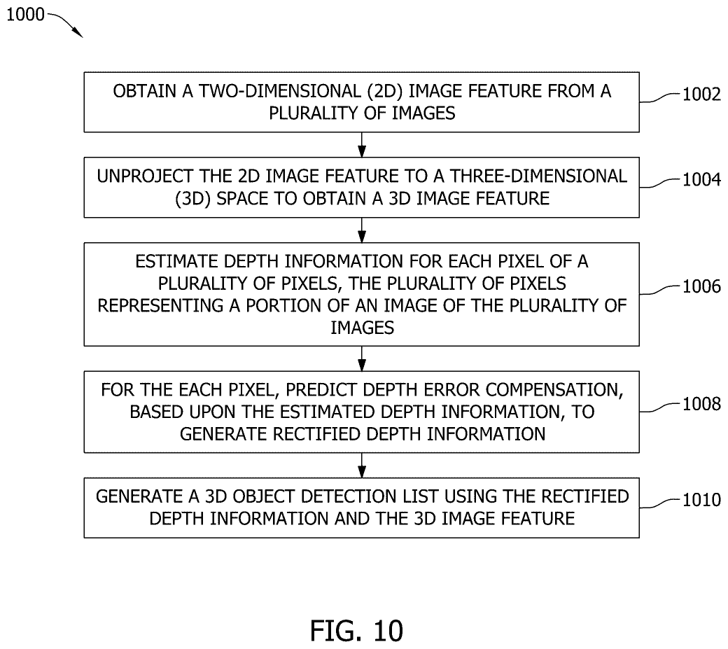

FIG. 10 is a flow chart 1000 of an example embodiment of a method of BEV object detection with online depth rectification. The method 1000 may be embodied in autonomy computing system 200 or, more specifically, BEV object detection module 242 (shown in FIG. 2), or processor 310 (shown in FIG. 3). The method operations include obtaining 1002 a two-dimensional (2D) image feature from a plurality of images. The plurality of images is generated based upon sensor data from a plurality of camera sensors, for example, camera sensors 214 shown in FIG. 2.

The method operations include unprojecting 1004 the 2D image feature to a three-dimensional (3D) space to obtain a 3D image feature. As described herein, unprojecting 1004 includes mapping a 2D point from an image of the plurality of images in the image's coordinate system (e.g., a 2D coordinate system) to a 3D coordinate system (e.g., 3D word coordinate system). As described herein, the 2D image feature is obtained using a 2D feature encoder. By way of an example, the 2D feature encoder may be a residual neural network (ResNet). The method operations include estimating 1006 depth information for each pixel of a plurality of pixels. The plurality of pixels represents a portion of an image of the plurality of images. Alternatively, the plurality of pixels represents an entire portion of an image of the plurality of images.

The method operations include, for the each pixel, predicting 1008 depth error compensation. The depth error compensation is predicted based upon the estimated depth information. The depth error compensation is applied to generate rectified depth information. The depth error compensation is predicted by generating a depth error compensation value for a current time instance based upon a plurality of samples at previous time instances or historical timestamps. Additionally, or alternatively, model parameters of a machine learning algorithm used for depth error compensation prediction may be updated for the current time instance based upon the plurality of samples at previous time instances or historical timestamps.

The method operations include generating 1010 a 3D object detection list (e.g., a first 3D object detection list) using the rectified depth information and the 3D image feature. The first 3D object detection list is generated using sensor data from at one LiDAR sensor or at least one RADAR sensor. Additionally, a second 3D object detection list is also generated using a point cloud based upon sensor data from the at least one LiDAR sensor or at least one RADAR sensor. Additionally, a third 3D object detection list is also obtained based on a feature level fusion of 3D image features and 3D LiDAR or RADAR features. Object level fusion of the third 3D object detection list is performed with the list of associated 3D objects and the list of unassociated 3D objects, as described in more detail herein. An output of detected 3D objects is generated based on the object level fusion.

An example technical effect of the methods, systems, and apparatus described herein includes at least improving object detection performance by reducing depth error. Additionally, the benefit of improved object detection performance is realized using a very small overhead to currently known BEV object detection techniques.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An autonomy computing system comprising:
at least one memory configured to store machine executable instructions; and
at least one processor coupled to the at least one memory and configured to execute the machine executable instructions to:
obtain a two-dimensional (2D) image feature from a plurality of images, the plurality of images generated based upon sensor data from a plurality of camera sensors;
unproject the 2D image feature to a three-dimensional (3D) space to obtain a 3D image feature;
estimate depth information for each pixel of a plurality of pixels, the plurality of pixels representing a portion of an image of the plurality of images;
for the each pixel, predict depth error compensation, based upon the estimated depth information, to generate rectified depth information; and
generate a 3D object detection list using the rectified depth information and the 3D image feature.

2. The system of claim 1, wherein the 3D object detection list is a first 3D object detection list, and wherein the at least one processor is further configured to execute the instructions to:
generate a second 3D object detection list using a point cloud, wherein the point cloud is generated based upon sensor data from at least one light detection and ranging (LiDAR) sensor or at least one radio detection and ranging (RADAR) sensor;
associate the first 3D object detection list with the second 3D object detection list; and
based on the association, identify a list of associated 3D objects and a list of unassociated 3D objects.

3. The system of claim 2, wherein the at least one processor is further configured to execute the instructions to:
obtain a third 3D object detection list based on a feature level fusion of 3D image features and 3D LiDAR or RADAR features;
perform object level fusion of the third 3D object detection list with the list of associated 3D objects and the list of unassociated 3D objects; and
generate an output of detected 3D objects based on the object level fusion.

4. The system of claim 1, wherein the 2D image feature is obtained using a 2D feature encoder.

5. The system of claim 4, wherein the 2D feature encoder is a residual neural network (ResNet).

6. The system of claim 1, wherein to predict the depth error compensation, the at least one processor is further configured to execute the instructions to generate a depth error compensation value for a current time instance based upon a plurality of samples at previous time instances or historical timestamps.

7. The system of claim 6, wherein to predict the depth error compensation, the at least one processor is further configured to execute the instructions to update model parameters for the current time instance based upon the plurality of samples at previous time instances or historical timestamps.

8. An autonomous vehicle comprising:
a plurality of sensors including one or more camera sensors, one or more light detection and ranging (LiDAR) sensors, or one or more radio detection and ranging (RADAR) sensors;
at least one memory configured to store machine executable instructions; and
at least one processor coupled to the at least one memory and the plurality of sensors, and configured to execute the machine executable instructions to:
obtain a two-dimensional (2D) image feature from a plurality of images, the plurality of images generated based upon sensor data from the one or more camera sensors;
unproject the 2D image feature to a three-dimensional (3D) space to obtain a 3D image feature;
estimate depth information for each pixel of a plurality of pixels, the plurality of pixels representing a portion of an image of the plurality of images;
for the each pixel, predict depth error compensation, based upon the estimated depth information, to generate rectified depth information; and
generate a 3D object detection list using the rectified depth information and the 3D image feature.

9. The autonomous vehicle of claim 8, wherein the 3D object detection list is a first 3D object detection list, and wherein the at least one processor is further configured to execute the instructions to:
generate a second 3D object detection list using a point cloud, wherein the point cloud is generated based upon sensor data the one or more LiDAR sensors or the one or more RADAR sensors;
associate the first 3D object detection list with the second 3D object detection list; and
based on the association, identify a list of associated 3D objects and a list of unassociated 3D objects.

10. The autonomous vehicle of claim 9, wherein the at least one processor is further configured to execute the instructions to:
obtain a third 3D object detection list based on a feature level fusion of 3D image features and 3D LiDAR or RADAR features;
perform object level fusion of the third 3D object detection list with the list of associated 3D objects and the list of unassociated 3D objects; and
generate an output of detected 3D objects based on the object level fusion.

11. The autonomous vehicle of claim 8, wherein the 2D image feature is obtained using a 2D feature encoder.

12. The autonomous vehicle of claim 11, wherein the 2D feature encoder is a residual neural network (ResNet).

13. The autonomous vehicle of claim 8, wherein to predict the depth error compensation, the at least one processor is further configured to execute the instructions to generate a depth error compensation value for a current time instance based upon a plurality of samples at previous time instances or historical timestamps.

14. The autonomous vehicle of claim 13, wherein to predict the depth error compensation, the at least one processor is further configured to execute the instructions to update model parameters for the current time instance based upon the plurality of samples at previous time instances or historical timestamps.

15. A computer-implemented method comprising:
obtaining a two-dimensional (2D) image feature from a plurality of images, the plurality of images generated based upon sensor data from one or more camera sensors;
unprojecting the 2D image feature to a three-dimensional (3D) space to obtain a 3D image feature;
estimating depth information for each pixel of a plurality of pixels, the plurality of pixels representing a portion of an image of the plurality of images;
for the each pixel, predicting depth error compensation, based upon the estimated depth information, to generate rectified depth information; and
generating a 3D object detection list using the rectified depth information and the 3D image feature.

16. The computer-implemented method of claim 15, wherein the 3D object detection list is a first 3D object detection list, and the method further comprising:
generating a second 3D object detection list using a point cloud, wherein the point cloud is generated based upon sensor data the one or more light detection and ranging (LiDAR) sensors or the one or more radio detection and ranging (RADAR) sensors;
associating the first 3D object detection list with the second 3D object detection list; and
based on the association, identifying a list of associated 3D objects and a list of unassociated 3D objects.

17. The computer-implemented method of claim 16 further comprising:
obtaining a third 3D object detection list based on a feature level fusion of 3D image features and 3D LiDAR or RADAR features;
performing object level fusion of the third 3D object detection list with the list of associated 3D objects and the list of unassociated 3D objects; and
generating an output of detected 3D objects based on the object level fusion.

18. The computer-implemented method of claim 15, wherein the 2D image feature is obtained using a 2D feature encoder; and wherein the 2D feature encoder is a residual neural network (ResNet).

19. The computer-implemented method of claim 15, wherein predicting the depth error compensation comprises generating a depth error compensation value for a current time instance based upon a plurality of samples at previous time instances or historical timestamps.

20. The computer-implemented method of claim 15, wherein predicting the depth error compensation comprises updating model parameters for the current time instance based upon the plurality of samples at previous time instances or historical timestamps.
